(19) United States
(12) Patent Application Publication
(10) Pub. No.: US 2020/0391977 A1
(43) Pub. Date: Dec. 17, 2020

(54) ELEVATOR CONTROL DEVICE

(71) Applicant: Mitsubishi Electric Corporation, Tokyo (JP)

(72) Inventor: Shunsuke ONO, Tokyo (JP)

(73) Assignee: Mitsubishi Electric Corporation, Tokyo (JP)

(21) Appl. No.: 16/957,111

(22) PCT Filed: Apr. 26, 2018
(86) PCT No.: PCT/JP2018/017034

§ 371 Date: Jun. 23, 2020

(51) Int. Cl. B66B 5/02; B66B 3/02; B66B 1/36

(52) U.S. Cl. CPC B66B 5/027; B66B 1/36; B66B 3/02

(57) ABSTRACT

There is provided an elevator control device that can recognize that a car is within a door openable range even when a landing device has failed. The elevator control device includes a control unit configured to, when the landing device of the elevator has failed, position the car within the door openable range based on a signal from another device that detects a position of the car of the elevator. With this configuration, even when the landing device has failed, it is possible to recognize that the car is within the door openable range based on the signal from the other device.

### FIELD

The present invention relates to an elevator control device.

### BACKGROUND

PTL 1 discloses an elevator landing device. The landing device can maintain detection accuracy of a position of a car even when the car is inclined.

### CITATION LIST

### Patent Literature

[PTL 1] JP 2008-56454 A

### SUMMARY

### Technical Problem

In the elevator disclosed in PTL 1, however, the landing device may fail. In this case, it is not possible to recognize that the car is within a door openable range.

The present invention is made to solve the above-described issue. An object of the present invention is to provide an elevator control device that can recognize that the car is within the door openable range even when the landing device has failed.

### Solution to Problem

An elevator control device according to the present invention includes a control unit configured to, when a landing device of an elevator has failed, position a car within a door openable range based on a signal from another device that detects a position of the car of the elevator.

### Advantageous Effects of Invention

According to the present invention, when the landing device has failed, the control device positions the car within the door openable range based on the signal from the other device that detects the position of the car of the elevator. Accordingly, even when the landing device has failed, it is possible to recognize that the car is within the door openable range.

### BRIEF DESCRIPTION OF DRAWINGS

FIG. 1 is a configuration diagram of an elevator to which an elevator control device according to Embodiment 1 is applied.

FIG. 2 is a flowchart to explain a first example of operation of the elevator control device according to Embodiment 1.

FIG. 3 is a flowchart to explain a second example of the operation of the elevator control device according to Embodiment 1.

FIG. 4 is a hardware configuration diagram of the elevator control device according to Embodiment 1.

### DESCRIPTION OF EMBODIMENTS

An embodiment of the present invention is described with reference to accompanying drawings. Note that, in the drawings, the same or equivalent components are denoted by the same reference numerals. Repetitive description of such components is appropriately simplified or omitted.

### Embodiment 1

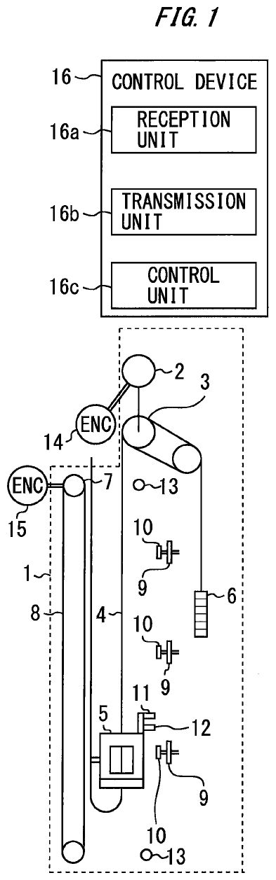

FIG. 1 is a configuration diagram of an elevator to which an elevator control device according to Embodiment 1 is applied.

In FIG. 1, a hoistway 1 penetrates through floors of an unillustrated building. A traction machine 2 is provided at an upper part of the hoistway 1. A sheave 3 is attached to a rotary shaft of the traction machine 2. A main rope 4 is wound around the sheave 3.

A car 5 is provided inside the hoistway 1. The car 5 is suspended from one side of the main rope 4. A counter weight 6 is provided inside the hoistway 1. The counter weight 6 is suspended from the other side of the main rope 4.

A governor 7 is provided at the upper part of the hoistway 1. A governor rope 8 is wound around the governor 7. The governor rope 8 is connected to the car 5.

A plurality of door zone plates 9 are provided at positions corresponding to door zones of the respective floors inside the hoistway 1. A plurality of releveling zone plates 10 are provided at positions corresponding to releveling zones of the respective floors inside the hoistway 1. A length of each of the releveling zone plates 10 in a vertical direction is shorter than a length of each of the door zone plates 9 in the vertical direction.

A landing device 11 is provided on the car 5. The landing device 11 is provided to, when being located at a height equivalent to any of the door zone plates 9, detect the corresponding door zone plate 9. The landing device 11 is provided to transmit a door zone signal while detecting any of the door zone plates 9.

A releveling device 12 is provided on the car 5. The releveling device 12 is provided to, when being located at a height equivalent to any of the releveling zone plates 10, detect the corresponding releveling zone plate 10. A detector for the releveling zone plate 10 is provided to transmit a releveling signal while detecting any of the releveling zone plates 10.

One of paired terminal stopping devices 13 is provided at the upper part of the hoistway 1. The other of the paired terminal stopping devices 13 is provided at a lower part of the hoistway 1.

A traction machine encoder 14 is connected to the traction machine 2. The traction machine encoder 14 is provided to transmit a traction machine encoder signal based on a rotation amount of the traction machine 2.

A governor encoder 15 is connected to the governor 7. The governor encoder 15 is provided to transmit a governor encoder signal based on a rotation amount of the governor 7.

A control device 16 includes a reception unit 16a, a transmission unit 16b, and a control unit 16c.

The reception unit 16a is provided such that the reception unit 16a can receive signals from the various kinds of devices of the elevator. The transmission unit 16b is provided such that the transmission unit 16b can transmit signals to the various kinds of devices of the elevator. The control unit 16c is provided such that the control unit 16c can wholly control the various kinds of devices of the elevator.

For example, the control device 16 determines that the car 5 is located within a door openable range while receiving the door zone signal from the landing device 11. For example, the control device 16 determines that a height of a floor surface of the car 5 and a height of a floor surface of a hall are coincident with each other while receiving the releveling signal from the releveling device 12. For example, the control device 16 determines that the car 5 is located at a preset position at the upper part of the hoistway 1 when the one of the paired terminal stopping devices 13 operates. For example, the control device 16 determines that the car 5 is located at a preset position at the lower part of the hoistway 1 when the other of the paired terminal stopping devices 13 operates. For example, the control device 16 grasps a moving distance of the car 5 based on the traction machine encoder signal from the traction machine encoder 14 or the governor encoder signal from the governor encoder 15.

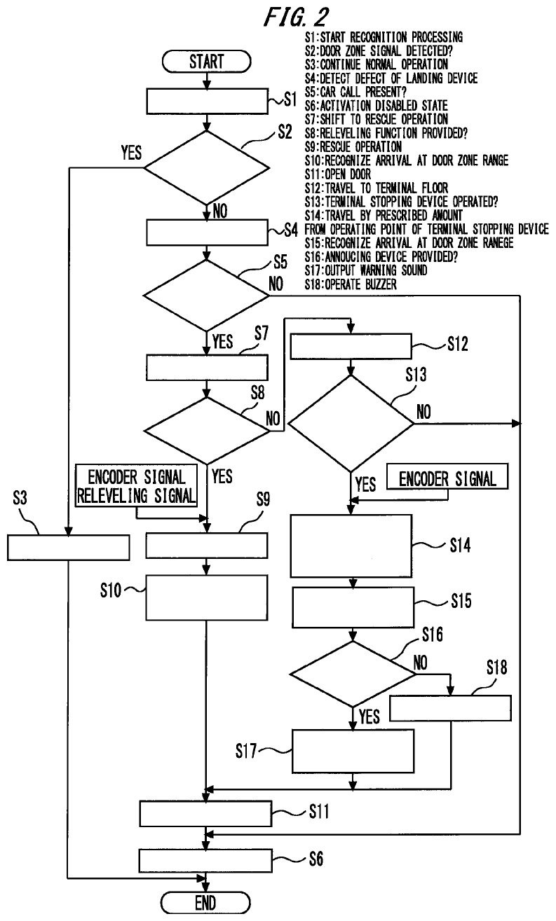

Next, a first example of operation of the control device 16 is described with reference to FIG. 2.

FIG. 2 is a flowchart to explain the first example of the operation of the elevator control device according to Embodiment 1.

In step S1, the control device 16 starts processing to recognize the door zone signal. Thereafter, the control device 16 performs operation in step S2. In step S2, the control device 16 determines whether the door zone signal has been detected.

In a case where the control device 16 has detected the door zone signal in step S2, the control device 16 performs operation in step S3. In step S3, the control device 16 continues normal operation of the elevator. Thereafter, the control device 16 ends the operation.

In a case where the control device 16 has not detected the door zone signal in step S2, the control device 16 performs operation in step S4. In step S4, the control device 16 detects a defect of the landing device 11. Thereafter, the control device 16 performs operation in step S5. In step S5, the control device 16 determines whether a car call is present.

In a case where no car call is present in step S5, the control device 16 performs operation in step S6. In step S6, the control device 16 puts the elevator into an activation disabled state. Thereafter, the control device 16 ends the operation.

In a case where a car call is present in step S5, the control device 16 performs operation in step S7. In step S7, the control device 16 shifts the operation of the elevator to rescue operation. Thereafter, the control device 16 performs operation in step S8. In step S8, the control device 16 determines whether a releveling function is provided.

In a case where the releveling function is provided in step S8, the control device 16 performs operation in step S9. In step S9, the control device 16 performs the rescue operation based on the encoder signal and the releveling signal. Thereafter, the control device 16 performs operation in step S10. In step S10, the control device 16 recognizes that the car 5 has arrived at a door zone range as the door openable range.

Thereafter, the control device 16 performs operation in step S11. In step S11, the control device 16 opens a door of the elevator. Thereafter, the control device 16 performs the operation in step S6. In step S6, the control device 16 puts the elevator into the activation disabled state. Thereafter, the control device 16 ends the operation.

In a case where the releveling function is not provided in step S8, the control device 16 performs operation in step S12. In step S12, the control device 16 causes the car 5 to travel to a terminal floor. Thereafter, the control device 16 performs operation in step S13. In step S13, the control device 16 determines whether any of the terminal stopping devices 13 has been operated.

In a case where no terminal stopping device 13 has operated in step S13, the control device 16 performs the operation in step S6. In step S6, the control device 16 puts the elevator into the activation disabled state. Thereafter, the control device 16 ends the operation.

In a case where any of the terminal stopping devices 13 has operated in step S13, the control device 16 performs operation in step S14. In step S14, the control device 16 causes the car 5 to travel by a prescribed amount from an operating point of the terminal stopping device 13 based on the encoder signal. Thereafter, the control device 16 performs operation in step S15. In step S15, the control device 16 recognizes that the car 5 has arrived at the door zone range as the door openable range. Thereafter, the control device 16 performs operation in step S16. In step S16, the control device 16 determines whether an unillustrated announcing device is provided.

In a case where the announcing device is provided in step S16, the control device 16 performs operation in step S17. In step S17, the control device 16 causes the announcing device to output warning sound notifying presence of step difference.

Thereafter, the control device 16 performs the operation in step S11. In step S11, the control device 16 opens the door of the elevator. Thereafter, the control device 16 performs the operation in step S6. In step S6, the control device 16 puts the elevator into the activation disabled state. Thereafter, the control device 16 ends the operation.

In a case where the announcing device is not provided in step S16, the control device 16 performs operation in step S18. In step S18, the control device 16 operates an unillustrated buzzer.

Thereafter, the control device 16 performs the operation in step S11. In step S11, the control device 16 opens the door of the elevator. Thereafter, the control device 16 performs the operation in step S6. In step S6, the control device 16 puts the elevator into the activation disabled state. Thereafter, the control device 16 ends the operation.

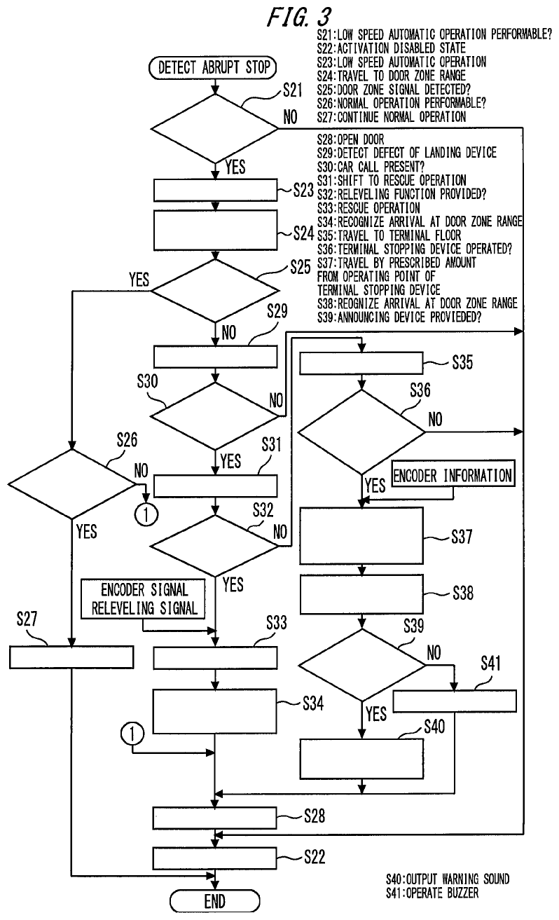

Next, a second example of the operation of the control device 16 is described with reference to FIG. 3.

FIG. 3 is a flowchart to explain the second example of the operation of the elevator control device according to Embodiment 1.

The control device 16 performs operation in step S21 when detecting abrupt stop of the car 5. In step S21, the control device 16 determines whether low speed automatic operation of the elevator is performable.

In a case where the low speed automatic operation of the elevator is not performable in step S21, the control device 16 performs operation in step S22. In step S22, the control device 16 puts the elevator into the activation disabled state. Thereafter, the control device 16 ends the operation.

In a case where the low speed automatic operation of the elevator is performable in step S22, the control device 16 performs operation in step S23. In step S23, the control device 16 performs the low speed automatic operation of the elevator. Thereafter, the control device 16 performs operation in step S24. In step S24, the control device 16 causes the car 5 to travel to a door zone range. Thereafter, the control device 16 performs operation in step S25. In step S25, the control device 16 determines whether the door zone signal has been detected.

In a case where the control device 16 has detected the door zone signal in step S25, the control device 16 performs operation in step S26. In step S26, the control device 16 determines whether the normal operation of the elevator is performable.

In a case where the normal operation of the elevator is performable in step S26, the control device 16 performs operation in step S27. In step S27, the control device 16 continues the normal operation of the elevator. Thereafter, the control device 16 ends the operation.

In a case where the normal operation of the elevator is not performable in step S26, the control device 16 performs operation in step S28. In step S28, the control device 16 opens the door of the elevator. Thereafter, the control device 16 performs the operation in step S22. In step S22, the control device 16 puts the elevator into the activation disabled state. Thereafter, the control device 16 ends the operation.

In a case where the control device 16 has not detected the door zone signal in step S25, the control device 16 performs operation in step S29. In step S29, the control device 16 detects a defect of the landing device 11. Thereafter, the control device 16 performs operation in step S30. In step S30, the control device 16 determines whether a car call is present.

In a case where no car call is present in step S30, the control device 16 performs the operation in step S22. In step S22, the control device 16 puts the elevator into the activation disabled state. Thereafter, the control device 16 ends the operation.

In a case where a car call is present in step S30, the control device 16 performs operation in step S31. In step S31, the control device 16 shifts the operation of the elevator to the rescue operation. Thereafter, the control device 16 performs operation in step S32. In step S32, the control device 16 determines whether the releveling function is provided.

In a case where the releveling function is provided in step S32, the control device 16 performs operation in step S33. In step S33, the control device 16 performs the rescue operation based on the encoder signal and the releveling signal. Thereafter, the control device 16 performs operation in step S34. In step S34, the control device 16 recognizes that the car 5 has arrived at the door zone range as the door openable range.

Thereafter, the control device 16 performs the operation in step S28. In step S28, the control device 16 opens the door of the elevator. Thereafter, the control device 16 performs the operation in step S22. In step S22, the control device 16 puts the elevator into the activation disabled state. Thereafter, the control device 16 ends the operation.

In a case where the releveling function is not provided in step S32, the control device 16 performs operation in step S35. In step S35, the control device 16 causes the car 5 to travel to the terminal floor. Thereafter, the control device 16 performs operation in step S36. In step S36, the control device 16 determines whether any of the terminal stopping devices 13 has been operated.

In a case where no terminal stopping device 13 has operated in step S36, the control device 16 performs the operation in step S22. In step S22, the control device 16 puts the elevator into the activation disabled state. Thereafter, the control device 16 ends the operation.

In a case where any of the terminal stopping devices 13 has operated in step S36, the control device 16 performs operation in step S37. In step S37, the control device 16 causes the car 5 to travel by a prescribed amount from an operating point of the terminal stopping device 13 based on the encoder information. Thereafter, the control device 16 performs operation in step S38. In step S38, the control device 16 recognizes that the car 5 has arrived at the door zone range as the door openable range. Thereafter, the control device 16 performs operation in step S39. In step S39, the control device 16 determines whether an announcing device is provided.

In a case where the announcing device is provided in step S39, the control device 16 performs operation in step S40. In step S40, the control device 16 causes the announcing device to output warning sound notifying presence of step difference.

Thereafter, the control device 16 performs the operation in step S28. In step S28, the control device 16 opens the door of the elevator. Thereafter, the control device 16 performs the operation in step S22. In step S22, the control device 16 puts the elevator into the activation disabled state. Thereafter, the control device 16 ends the operation.

In a case where the announcing device is not provided in step S39, the control device 16 performs operation in step S41. In step S41, the control device 16 operates a buzzer.

Thereafter, the control device 16 performs the operation in step S28. In step S28, the control device 16 opens the door of the elevator. Thereafter, the control device 16 performs the operation in step S22. In step S22, the control device 16 puts the elevator into the activation disabled state. Thereafter, the control device 16 ends the operation.

According to Embodiment 1 described above, when the landing device 11 has failed, the control device 16 positions the car 5 within the door openable range based on the signal from the other device that detects the position of the car 5 of the elevator. Therefore, even when the landing device 11 has failed, it is possible to recognize that the car 5 is within the door openable range.

For example, the control device 16 positions the car 5 within the door openable range based on the releveling signal from the releveling device 12. For example, the control device 16 positions the car 5 within the door openable range from the operating point of the terminal stopping device 13 based on the traction machine encoder signal from the traction machine encoder 14 or the governor encoder signal from the governor encoder 15. Accordingly, even when the landing device 11 has failed, it is possible to recognize that the car 5 is within the door openable range without additionally including a new device.

Further, the control device 16 positions the car 5 within the door openable range, and then opens the door of the elevator. Accordingly, even if a user is present inside the car 5 when the landing device 11 has failed, it is possible to rescue the user.

Further, the control device 16 causes the announcing device to output warning sound when positioning the car 5 within the door openable range. Accordingly, it is possible to urge the user inside the car 5 to take precautions against step difference between the floor surface of the car 5 and the floor surface of the hall.

Further, the control device 16 operates the buzzer when positioning the car 5 within the door openable range. Therefore, it is possible to urge the user inside the car 5 to take precautions against the step difference between the floor surface of the car 5 and the floor surface of the hall.

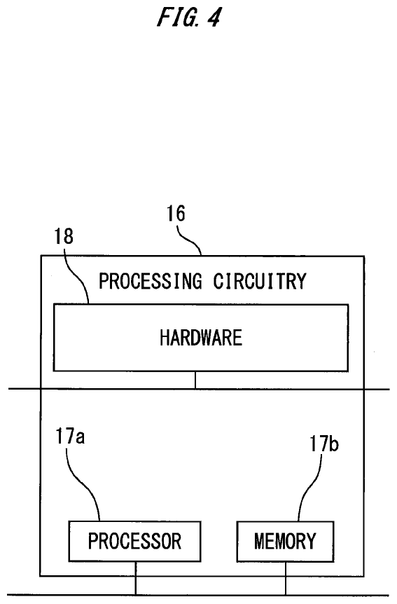

Next, an example of the control device 16 is described with reference to FIG. 4.

FIG. 4 is a hardware configuration diagram of the elevator control device according to Embodiment 1.

Each of the functions of the control device 16 can be realized by a processing circuitry. For example, the processing circuitry includes at least one processor 17a and at least one memory 17b. For example, the processing circuitry includes at least one dedicated hardware 18.

In a case where the processing circuitry includes the at least one processor 17a and the at least one memory 17b, each of the functions of the control device 16 is realized by software, firmware, or a combination of software and firmware. At least one of the software and the firmware is described as a program. At least one of the software and the firmware is stored in the at least one memory 17b. The at least one processor 17a realizes each of the functions of the control device 16 by reading out and executing the program stored in the at least one memory 17b. The at least one processor 17a is also referred to as a central processing unit, a processor, a calculation unit, a microprocessor, a microcomputer, or a DSP. For example, the at least one memory 17b is a nonvolatile or volatile semiconductor memory such as a RAM, a ROM, a flash memory, an EPROM, and an EEPROM, a magnetic disk, a flexible disk, an optical disk, a compact disk, a mini disk, a DVD, or the like.

In a case where the processing circuitry includes the at least one dedicated hardware 18, the processing circuitry is realized by, for example, a single circuitry, a composite circuitry, a programmed processor, a parallel-programmed processor, an ASIC, an FPGA, or a combination thereof. For example, each of the functions of the control device 16 is realized by the processing circuitry. For example, the functions of the control device 16 are collectively realized by the processing circuitry.

A part of the functions of the control device 16 may be realized by the dedicated hardware 18, and the other part may be realized by software or firmware. For example, the function of the control unit 16c may be realized by the processing circuitry as the dedicated hardware 18, and functions other than the function of the control unit 16c may be realized when the at least one processor 17a reads out and executes the program stored in the at least one memory 17b.

As described above, the processing circuitry realizes each of the functions of the control device 16 by the hardware 18, software, firmware, or a combination thereof.

### INDUSTRIAL APPLICABILITY

As described above, the elevator control device according to the present invention can be used for a system recognizing that the car is within the door openable range.

### REFERENCE SIGNS LIST

1 Hoistway
2 Traction machine
3 Sheave
4 Main rope
5 Car
6 Counter weight
7 Governor
8 Governor rope
9 Door zone plate
10 Releveling zone plate
11 Landing device
12 Releveling device
13 Terminal stopping device
14 Traction machine encoder
15 Governor encoder
16 Control device
16a Reception unit
16b Transmission unit
16c Control unit
17a Processor
17b Memory
18 Hardware

1. An elevator control device comprising a controller configured to, when a landing device of an elevator has failed, position a car within a door openable range based on a signal from another device that detects a position of the car of the elevator,
wherein the controller positions the car within the door openable range from an operating point of a terminal stopping device of the elevator based on a signal from an encoder that detects a rotation amount of a traction machine or a governor of the elevator.

2.-3. (canceled)

4. The elevator control device according to claim 1, wherein the controller positions the car within the door openable range based on the signal from the other device that detects the position of the car of the elevator, and then opens a door of the elevator.

5. The elevator control device according to claim 4, wherein the controller causes an announcing device of the elevator to output warning sound when positioning the car within the door openable range.

6. The elevator control device according to claim 4, wherein the controller operates a buzzer of the elevator when positioning the car within the door openable range.
